(19) United States
(12) Patent Application Publication
(10) Pub. No.: US 2026/0186238 A1
(43) Pub. Date: Jul. 2, 2026

(54) PRISM MOTOR MODULE

(71) Applicant: Luxvisions Innovation Technology Corp. Limited, Guangzhou City (CN)

(72) Inventors: Xin-Xin Xu, Guangzhou City (CN); Zhuo-Hong Li, Guangzhou City (CN); Jia-Dong Zhang, Guangzhou City (CN)

(73) Assignee: Luxvisions Innovation Technology Corp. Limited, Guangzhou City (CN)

(21) Appl. No.: 19/392,274

(22) Filed: Nov. 18, 2025

(30) Foreign Application Priority Data
Dec. 31, 2024 (CN) 202411997395.7

(51) Int. Cl. G02B 7/18

(52) U.S. Cl. CPC G02B 7/1805

(57) ABSTRACT

A prism motor module includes a prism bracket, a prism carrier, a prism, and two shaft elements. The prism bracket has an accommodating groove. Each accommodating groove includes a first rolling trench, a second rolling trench, a first rolling member, and a second rolling member. The first rolling member rolls in the first rolling trench and the second rolling member rolls in the second rolling trench. The prism carrier is arranged on the prism bracket, and the prism is correspondingly arranged on the prism carrier. The two shaft elements are arranged on two sides of the prism carrier. Each shaft element is correspondingly arranged in an accommodating groove and simultaneously abuts against the first rolling member and the second rolling member of the accommodating groove, so that the prism carrier rotates along the first axis with the shaft element as an axis.

### CROSS-REFERENCE TO RELATED APPLICATION

This non-provisional application claims priority under 35 U.S.C. § 119(a) to Patent Application No. 202411997395.7 filed in China on Dec. 31, 2024, the entire contents of which are hereby incorporated by reference.

### BACKGROUND

### Technical Field

The present invention relates to a prism motor module, and in particular, to a prism motor module used in a periscope image capturing device to drive a prism into motion.

### Related Art

In a periscope image capturing device, an image is formed on a sensor through a prism and a lens. The lens is equipped with a motor for an auto focus (AF) function, and the prism motor provides an optical image stabilization (OIS) function. Specifically, the prism motor may control different movable members through different magnetic systems to achieve rotational motion in different axial directions, so as to compensate for rotation angles required in different axial directions. However, in an existing structure, plastic members are adopted between different movable members, and direct large-area contact with the plastic members generates friction and causes excessive dynamic and static friction when the movable members move relative to each other, resulting in a problem of jitter when switching at small angles.

### SUMMARY

In view of this, according to an embodiment, a prism motor module is provided, including a prism bracket, a prism carrier, a prism, and two shaft elements. The prism bracket has an accommodating groove on each of two side walls arranged in parallel. Each accommodating groove includes a first rolling trench, a second rolling trench, a first rolling member, and a second rolling member. The first rolling member rolls in the first rolling trench, the second rolling member rolls in the second rolling trench, and the first rolling trench and the second rolling trench are provided at an interval in sequence along a circumference of a first axis. The prism carrier is arranged on the prism bracket, and the prism is correspondingly arranged on the prism carrier. The two shaft elements are arranged on two sides of the prism carrier. Each shaft element is correspondingly arranged in an accommodating groove and simultaneously abuts against the first rolling member and the second rolling member of the accommodating groove, so that the prism carrier rotates along the first axis with the shaft element as an axis.

In an embodiment, the two shaft elements are made of metal or a ceramic material.

In an embodiment, a metal sheet is arranged on a bottom of each of the first rolling trench and the second rolling trench.

In an embodiment, the prism motor module further includes a fixing base. The fixing base includes a body and a driving module. The body has a bottom surface and two side surfaces perpendicular to the bottom surface. The driving module includes a first coil assembly and a second coil assembly. The first coil assembly is arranged on the bottom surface, and the second coil assembly is arranged on each of the two side surfaces. The bottom of the prism carrier is provided with a first magnet module corresponding to the first coil assembly. The prism bracket is arranged on the fixing base, and the two side walls of the prism bracket are further each provided with a second magnet module corresponding to the second coil assembly.

In an embodiment, the second magnet module and the accommodating groove are respectively located on two opposite sides of the side wall.

In an embodiment, the prism motor module further includes two fixing base elastic members. One end of each of the fixing base elastic members is connected to the fixing base, and the other end is connected to the prism bracket.

In an embodiment, the prism motor module further includes two bracket elastic members. One end of each of the bracket elastic members is connected to the prism carrier, and the other end is connected to the prism bracket.

In an embodiment, the first rolling member and the second rolling member are balls, and a depth of each of the first rolling trench and the second rolling trench is less than a diameter of each of the first rolling member and the second rolling member.

In an embodiment, an angle of an arc between ends of the first rolling trench and the second rolling trench that are farthest apart is less than or equal to 180 degrees.

In an embodiment, the ends of the first rolling trench and the second rolling trench that are farthest apart are both open ends.

Based on the above, according to an embodiment, this application provides a prism motor module, so that the contact between movable members such as a prism bracket and a prism carrier is achieved through contact between a rolling member and a shaft element. By replacing surface contact with point contact, the dynamic and static friction between the prism bracket and the prism carrier during relative motion is reduced to alleviate the problem of jitter in the OIS function structure that may be caused by the motor when switching at small angles due to the dynamic and static friction. In addition, through the rolling member or the shaft element made of metal or the ceramic material, the friction may be further reduced, and structural strength may be increased.

The present invention is described in detail below with reference to the accompanying drawings and specific embodiments, which are not intended to constitute a limitation on the present invention.

### BRIEF DESCRIPTION OF THE DRAWINGS

FIG. 1 is a three-dimensional view of a prism motor module according to an embodiment.

FIG. 2 is a three-dimensional exploded view of the prism motor module shown in FIG. 1.

FIG. 3 is a cross-sectional view of a position 3-3 marked in FIG. 1.

### DETAILED DESCRIPTION

Embodiments of the present invention are described in detail below, and illustrated with reference to the accompanying drawings as examples. In addition to these detailed descriptions, the present invention may further be widely implemented in other embodiments. Any easy substitution, modification, and equivalent changes of the embodiments are all included in the scope of the present invention, and the scope of the claims shall prevail. In the description of the specification, to make a reader have relatively complete understanding of the present invention, many specific details and implementation examples are provided. However, these specific details and implementation examples should not be construed as limitations on the present invention. In addition, well-known steps or elements have not been described in detail to avoid causing an unnecessary limitation on the present invention.

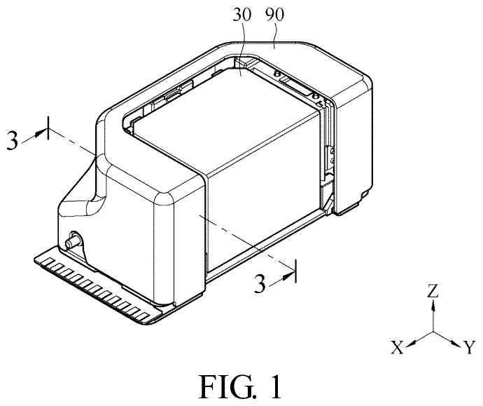

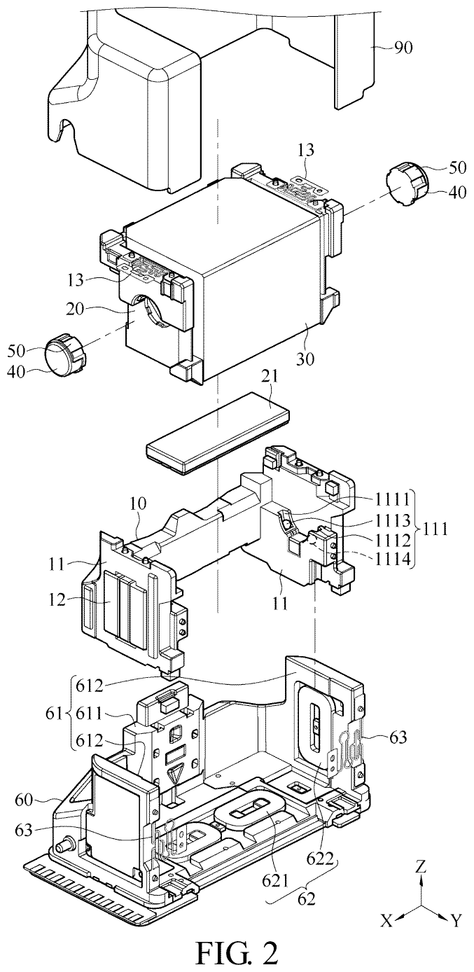

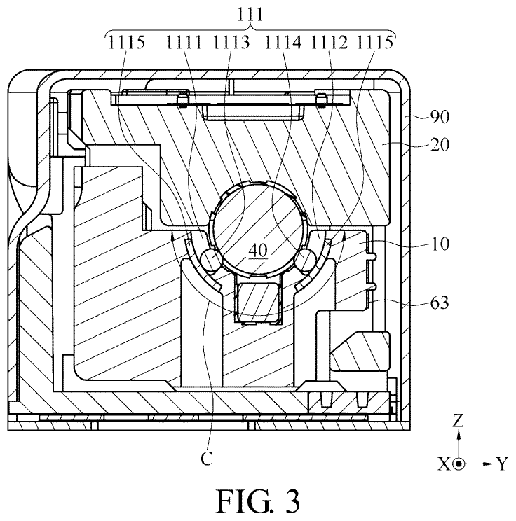

Refer to FIG. 1 to FIG. 3. FIG. 1 is a three-dimensional view of a prism motor module according to an embodiment, FIG. 2 is a three-dimensional exploded view of a prism motor module shown in FIG. 1, and FIG. 3 is a cross-sectional view of a position 3-3 marked in FIG. 1. The prism motor module of this embodiment may be applied to a periscope image capturing device such as a mobile phone camera device, an augmented reality device, or an on-board camera device with image auto focus and optical image stabilization (OIS) functions. It may be seen from FIG. 2 that the prism motor module of this embodiment includes a prism bracket 10, a prism carrier 20, a prism 30, and two shaft elements 40. In addition, to facilitate subsequent description, a direction extending along a long side of the prism motor module is set as a first axis X, a direction extending along a short side of the prism motor module is set as a second axis Y, and a direction extending along a height of the prism motor module is set as a third axis Z. The first axis X, the second axis Y, and the third axis Z are perpendicular to each other. Furthermore, as shown in FIG. 1 and FIG. 2, to prevent internal assemblies of the prism motor module during motion from being disturbed by external elements and maintain overall aesthetics, a housing 90 may be arranged on an outermost side of the prism motor module to cover the entire prism motor module.

The prism bracket 10 has an accommodating groove 111 on each of two side walls 11 arranged in parallel. In other words, two accommodating grooves 111 are provided in total on the prism bracket 10. The two accommodating grooves 111 are provided on two opposite side walls 11, that is, the accommodating grooves 111 are respectively provided on left and right side walls 11 and opposite to each other. Since the accommodating grooves 111 on left and right sides are symmetrically arranged and have the same structure, a cross-sectional view of the accommodating groove 111 located on a right side in FIG. 2 and the accommodating groove 111 located on a left side in FIG. 3 is used for description below. It may be seen from FIG. 2 and FIG. 3 that the accommodating groove 111 includes a first rolling trench 1111, a second rolling trench 1112, a first rolling member 1113, and a second rolling member 1114. The first rolling member 1113 rolls in the first rolling trench 1111, and the second rolling member 1114 rolls in the second rolling trench 1112.

It may be seen from FIG. 3 that the first rolling trench 1111 and the second rolling trench 1112 are provided at an interval in sequence along a circumference of the first axis X. Further, in this embodiment, an axis of the shaft element 40 is parallel to the first axis X, the first rolling trench 1111 and the second rolling trench 1112 are provided in an arc shape in sequence along an outer circumference of the shaft element 40, and an interval is defined between the first rolling trench 1111 and the second rolling trench 1112.

The first rolling member 1113 and the second rolling member 1114 may be elements such as balls or rollers that roll in the first rolling trench 1111 and the second rolling trench 1112 in a point contact or line contact manner, to achieve a rolling friction structure.

The prism carrier 20 is correspondingly arranged on the prism bracket 10, and the prism 30 is arranged on the prism carrier 20. The two shaft elements 40 are arranged on two sides of the prism carrier 20. The two shaft elements 40 may be bonded to the prism carrier 20 through adhesive 50. In addition, the two shaft elements 40 and the prism carrier 20 may also be formed into an integral structure through injection molding. Each shaft element 40 is correspondingly arranged in an accommodating groove 111 and simultaneously abuts against the first rolling member 1113 and the second rolling member 1114 of the accommodating groove 111, so that the prism carrier 20 rotates along the first axis X with the shaft element 40 as an axis.

In this way, the prism motor module enables the contact between movable members such as the prism bracket 10 and the prism carrier 20 to be achieved through contact between a rolling member (such as the first rolling member 1113 and the second rolling member 1114) and the shaft element 40. By replacing surface contact with point contact, the dynamic and static friction between the prism bracket 10 and the prism carrier 20 during relative motion is reduced to alleviate the problem of jitter in the OIS function structure that may be caused by the motor when switching at small angles due to the dynamic and static friction.

To further reduce impact of friction generated during relative motion between elements, the two shaft elements 40 may be made of metal or a ceramic material. In this way, structural strength may further be increased while reducing the friction.

In addition, it may be seen from FIG. 3 that a metal sheet 1115 is arranged on a bottom of each of the first rolling trench 1111 and the second rolling trench 1112. The first rolling member 1113 and the second rolling member 1114 are to come into contact with the metal sheet 1115 when rolling in the first rolling trench 1111 and the second rolling trench 1112. Since the friction of the metal sheet 1115 is lower than that of a material such as plastic, the friction of the first rolling member 1113 and the second rolling member 1114 when rolling in the first rolling trench 1111 and the second rolling trench 1112 may also be reduced.

Still refer to FIG. 1 to FIG. 3. In this embodiment, the prism motor module further includes a fixing base 60. The fixing base 60 includes a body 61 and a driving module 62. The body 61 has a bottom surface 611 and two side surfaces 612 perpendicular to the bottom surface 611. The driving module 62 includes a first coil assembly 621 and a second coil assembly 622. The first coil assembly 621 is arranged on the bottom surface 611, and the second coil assembly 622 is arranged on each of the two side surfaces 612. The bottom of the prism carrier 20 is provided with a first magnet module 21 corresponding to the first coil assembly 621. The prism bracket 10 is arranged on the fixing base 60, and the two side walls 11 of the prism bracket 10 are further each provided with a second magnet module 12 corresponding to the second coil assembly 622.

FIG. 2 shows only the second coil assembly 622 arranged on one of the side surfaces 612, and a same second coil assembly 622 is also arranged on an inner side of the opposite side surface 612. FIG. 2 shows only the second magnet module 12 (a side wall 11 on the left) arranged on one of the side walls 11, and a same second magnet module 12 is also arranged on an outer side of the opposite side wall 11 (a side wall 11 on the right). Through the second coil assemblies 622 and the second magnet modules 12 in pair correspondingly arranged on the left and right sides, magnetic thrust may be formed on the prism bracket 10 at a symmetrical position to control motion of prism bracket 10.

The second magnet module 12 and the accommodating groove 111 are respectively provided on two opposite sides of the side wall 11. It may be learned from FIG. 2 that two second magnet modules 12 are to be arranged on an outer side surface of the side wall 11, and two accommodating grooves 111 are provided on an inner side surface of the side wall 11. From the perspective of each side wall 11, the second magnet module 12 and the accommodating groove 111 are to be formed on two different side surfaces of the side wall 11. In this way, in addition to enabling the second magnet module 12 to correspond to the second coil assembly 622 of the fixing base 60, the second magnet module 12 may also be prevented from affecting motion of the first rolling member 1113 and the second rolling member 1114 arranged in the accommodating groove 111.

It may be seen from FIG. 2 that the prism motor module further includes two fixing base elastic members 63. One end of each of the fixing base elastic members 63 is connected to the fixing base 60, and the other end is connected to the prism bracket 10. Through an elastic acting force of the two fixing base elastic members 63, a range of relative motion between the fixing base 60 and the prism bracket 10 may be slightly restricted.

In addition, the prism motor module further includes two bracket elastic members 13. One end of each of the bracket elastic members 13 is connected to the prism carrier 20, and the other end is connected to the prism bracket 10. Through an elastic acting force of the two bracket elastic members 13, a range of relative motion between the prism bracket 10 and the prism carrier 20 may be slightly restricted.

In this embodiment, the first rolling member 1113 and the second rolling member 1114 are balls, and a depth of each of the first rolling trench 1111 and the second rolling trench 1112 is less than a diameter of each of the first rolling member 1113 and the second rolling member 1114. It may be seen from FIG. 3 that the first rolling member 1113 and the second rolling member 1114 slightly protrude from the first rolling trench 1111 and the second rolling trench 1112. It may be learned that a diameter of the ball is greater than a depth of the rolling trench. In another implementation, the diameter of the ball may be set as large as possible to push the shaft element 40 up, to prevent the shaft element 40 from directly contacting the first rolling trench 1111 or the second rolling trench 1112 or even the prism bracket 10 during the motion.

In addition, it may be seen from FIG. 3 that an angle of an arc C between ends of the first rolling trench 1111 and the second rolling trench 1112 that are farthest apart is less than or equal to 180 degrees. In this embodiment, although an example in which the arc C between the first rolling trench 1111 and the second rolling trench 1112 is slightly equal to 180 degrees is used, the angle formed by the arc C between the ends of the first rolling trench 1111 and the second rolling trench 1112 that are farthest apart may also be less than 180 degrees. In this way, the shaft element 40 may further be prevented from being excessively close to the prism bracket 10 when the first rolling member 1113 and the second rolling member 1114 move to a position farthest from the two during the rolling.

It may be seen from FIG. 2 and FIG. 3 that the ends of the first rolling trench 1111 and the second rolling trench 1112 that are farthest apart are both open ends. In this way, when the first rolling member 1113 and the second rolling member 1114 need to be arranged, the first rolling member and the second rolling member may be directly placed into the first rolling trench 1111 and the second rolling trench 1112 through the open end. If the first rolling member 1113 and the second rolling member 1114 are to be replaced, it is also relatively easy to remove the first rolling member and the second rolling member through the open ends of the first rolling trench 1111 and the second rolling trench 1112.

Certainly, the present invention may have various other embodiments. Without departing from the spirit of the present invention and its essence, a person skilled in the art may make various corresponding changes and modifications according to the present invention, but these corresponding changes and modifications shall fall within the protection scope of the claims appended to the present invention.

What is claimed is:

1. A prism motor module, comprising:
a prism bracket, having an accommodating groove on each of two side walls arranged in parallel, wherein each accommodating groove comprises a first rolling trench, a second rolling trench, a first rolling member, and a second rolling member, the first rolling member rolls in the first rolling trench, the second rolling member rolls in the second rolling trench, and the first rolling trench and the second rolling trench are provided at an interval in sequence along a circumference of a first axis;
a prism carrier, correspondingly arranged on the prism bracket;
a prism, arranged on the prism carrier; and
two shaft elements, arranged on two sides of the prism carrier, wherein each of the shaft elements is correspondingly arranged in the accommodating groove and simultaneously abuts against the first rolling member and the second rolling member of the accommodating groove, so that the prism carrier rotates along the first axis with the shaft element as an axis.

2. The prism motor module according to claim 1, wherein the two shaft elements are made of metal or a ceramic material.

3. The prism motor module according to claim 1, wherein a metal sheet is arranged on a bottom of each of the first rolling trench and the second rolling trench.

4. The prism motor module according to claim 1, further comprising a fixing base, wherein the fixing base comprises:
a body, having a bottom surface and two side surfaces perpendicular to the bottom surface; and
a driving module, comprising a first coil assembly and a second coil assembly, wherein the first coil assembly is arranged on the bottom surface, and the second coil assembly is arranged on the two side surfaces, wherein
a bottom of the prism carrier is provided with a first magnet module corresponding to the first coil assembly, the prism bracket is arranged on the fixing base, and the two side walls of the prism bracket are further each provided with a second magnet module corresponding to the second coil assembly.

5. The prism motor module according to claim 4, wherein the second magnet module and the accommodating groove are respectively provided on two opposite sides of the side wall.

6. The prism motor module according to claim 4, further comprising two fixing base elastic members, wherein one end of each of the fixing base elastic members is connected to the fixing base, and the other end is connected to the prism bracket.

7. The prism motor module according to claim 1, further comprising two bracket elastic members, wherein one end of each of the bracket elastic members is connected to the prism carrier, and the other end is connected to the prism bracket.

8. The prism motor module according to claim 1, wherein the first rolling member and the second rolling member are balls, and a depth of each of the first rolling trench and the second rolling trench is less than a diameter of each of the first rolling member and the second rolling member.

9. The prism motor module according to claim 1, wherein an angle of an arc between ends of the first rolling trench and the second rolling trench that are farthest apart is less than or equal to 180 degrees.

10. The prism motor module according to claim 1, wherein the ends of the first rolling trench and the second rolling trench that are farthest apart are both open ends.
